(19) United States
(12) Patent Application Publication
(10) Pub. No.: US 2016/0323707 A1
(43) Pub. Date: Nov. 3, 2016

(54) MOBILE SOCIAL CONNECTION TOOL, SYSTEM, AND SERVICE

(71) Applicant: WYC Enterprises, LLC, Coral Gables, FL (US)

(72) Inventors: Chris Dupuy, Coral Gables, FL (US); Afife Soraya Vidal, Miami, FL (US)

(73) Assignee: WYC Enterprises, LLC, Coral Gables, FL (US)

(21) Appl. No.: 15/143,689

(22) Filed: May 2, 2016

Related U.S. Application Data
(60) Provisional application No. 62/156,229, filed on May 2, 2015.

(51) Int. Cl. H04W 4/02; G06Q 50/00; H04L 12/58; H04W 4/20; H04L 29/08

(52) U.S. Cl. CPC H04W 4/023; H04W 4/206; H04L 67/306; H04L 51/12; H04L 51/32; G06Q 50/01

(57) ABSTRACT

A location-based mobile social connection tool facilitates social interaction with other users in a physical setting by integrating various technologies in a user-friendly application to easily identify who is available or willing to engage in social interaction.

### CROSS-REFERENCE TO RELATED APPLICATIONS

This application is a non-provisional of, and claims priority to, United States Provisional Patent Application No. 62/156,229 filed on May 2, 2015; which application is incorporated herein by reference.

### STATEMENT REGARDING FEDERALLY SPONSORED-RESEARCH OR DEVELOPMENT

None.

### FIELD OF THE INVENTION

The invention disclosed broadly relates to the field of mobile device location-based applications, and more particularly relates to the field of location-based mobile device applications for social connections.

### BACKGROUND OF THE INVENTION

Social media sites are immensely popular in today's increasingly tech-savvy society. The need to connect with others is a basic human desire that drives the popularity of sites such as Facebook®, Twitter®, Meetville®, Instagram®, and Snapchat®, among others. On-line dating sites such as Match.com, Tinder®, and eHarmony®, to name a few, are popular because they connect people on-line in the hope that an on-line connection leads to a real-world romance.

But what about meeting people in the real world, in person? That proves more difficult. How do you identify a person who is open to social interaction, conversation or having a drink, as opposed to someone who is not socially available? Approaching a stranger in a bar, restaurant, or event can be a humiliating experience. No one wants me to be rejected. Conversely, being the one who is receiving unwanted attention can be extremely uncomfortable.

It is also difficult to identify if one person in a group of people might be “approachable,” i.e. amenable to social interaction. As an example, consider a scenario where a social group at a bar includes two women and two men. One might assume that the group consists of two married couples, and all four are therefore off limits. However, what if at least one of the members of the social group is not in a relationship and is available for social interaction? Not having any information about the availability status of your fellow bar patrons can mean a lost opportunity.

Even with so many on-line social networking tools available, there is no comfortable, easy way to bring socially-available people together in one location.

### SUMMARY OF THE INVENTION

Briefly, according to an embodiment of the present disclosure, a computer-implemented location-based social connection method includes steps or acts of: providing a mobile social connection tool with a graphical user interface on a client device associated with a first user for facilitating user interaction with a location-based mobile social connection service hosted by a server; through the graphical user interface: receiving input including socially relevant data from the first user; receiving a check-in request from the first user while he/she is present in a zone participating in the location-based mobile social connection service; providing a check-in screen upon receiving the request, wherein the check-in screen includes a social selection tool whereby the first user selects a social status indicating his/her current willingness to socialize while in the zone; and receiving the social status from the first user; checking in the first user to the zone, said checking in including: revealing the social status and the socially relevant data of the first user to other participants in the zone where the first user is currently checked in; providing the social status and the socially relevant data of other participants in the zone where the first user is currently checked in; and enabling/disabling social interaction among participants in the zone, depending on the social status selections and check-in status; and monitoring a continued presence and the social status selections of participants in the zone, whereby a computer-implemented location-based mobile social connection is provided.

According to another embodiment of the present disclosure, a location-based mobile social connection tool is provided on a client device. The location-based mobile social connection tool includes: a graphical user interface for facilitating user interaction with a location-based social connection service hosted on a server, wherein the graphical user interface is operably coupled with a location tool providing a location of the user's client device to the server. The graphical user interface performs steps or acts of: accepting input that includes socially relevant data from the user; accepting a check-in request while the user is present in a zone participating in the location-based mobile social connection service; providing a check-in screen with a social selection tool whereby the user selects a social status indicating the user's current willingness to socialize while in the zone; and responsive to receiving confirmation of the user's successful check-in to the zone, performing: revealing the social status and socially relevant data of the user to other participants who are also checked into the zone; providing the social status and the socially relevant data of other participants in the zone; and enabling/disabling social interaction among participants in the zone, depending on social status selections and check-in status.

According to another embodiment of the present disclosure, a computer-implemented location-based mobile social connection system includes: a mobile social connection tool provided on a client device; and a server hosting the location-based mobile social connection service. The server includes: a check-in engine; an interaction control engine; a monetization engine; a register engine; a location/zone engine; and a monitoring engine.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 illustrates a high-level block diagram of a mobile social connection system, according to an embodiment herein;

FIG. 2 illustrates a high-level flowchart of a mobile social connection service from the client-side, according to an embodiment herein;

FIG. 3 illustrates a high-level flowchart of a mobile social connection service, from the server-side, according to an embodiment herein;

FIGS. 4 through 32b are exemplary screenshots of implementations of the mobile social connection tool, according to an embodiment herein;

FIG. 4 illustrates an example of the mobile social connection application user interface, according to an embodiment herein;

FIG. 5 illustrates an exemplary login screen, according to an embodiment herein;

FIG. 6 illustrates an exemplary home screen, according to an embodiment herein;

FIG. 7 illustrates an exemplary check-in screen for site selection, according to an embodiment herein;

FIG. 8 illustrates an exemplary check-in screen once the site has been selected, according to an embodiment herein;

FIG. 9 illustrates a subsequent check-in screen for status selection, according to an embodiment herein;

FIG. 10 illustrates an Edit Profile screen, according to an embodiment herein;

FIG. 11 illustrates an Update Status screen, according to an embodiment herein;

FIG. 12a illustrates a map view of zones showing regular locations as pins, according to an embodiment herein;

FIG. 12b illustrates a map view of zones showing MSCT Zone locations with a special icon, according to an embodiment herein;

FIG. 13 illustrates an exemplary registration screen, according to an embodiment herein;

FIG. 14 illustrates an exemplary zone search screen, according to an embodiment herein;

FIG. 15 illustrates an exemplary settings screen, according to an embodiment herein;

FIG. 16 illustrates an exemplary side navigation bar, according to an embodiment herein;

FIG. 17 illustrates an exemplary message preview screen, according to an embodiment herein;

FIG. 18 illustrates an exemplary chat screen, according to an embodiment herein;

FIG. 19 illustrates an exemplary wink, according to an embodiment herein;

FIG. 20 illustrates an exemplary screen for blocking a user, according to an embodiment herein;

FIG. 21 illustrates an exemplary screen showing a block confirmation, according to an embodiment herein;

FIG. 22 illustrates an exemplary notifications screen, according to an embodiment herein;

FIG. 23 illustrates an exemplary message-by-zone screen, according to an embodiment herein;

FIG. 24 illustrates an exemplary screen showing blocked users, according to an embodiment herein;

FIG. 25 illustrates an exemplary screen showing push notifications, according to an embodiment herein;

FIG. 26 illustrates an exemplary check-in to chat screen, according to an embodiment herein;

FIG. 27 illustrates an exemplary upgrade screen, according to an embodiment herein;

FIG. 28 illustrates an exemplary screen view after unlocking, according to an embodiment herein;

FIG. 29 illustrates an exemplary pop-up window, according to an embodiment herein;

FIG. 30 illustrates an exemplary profile screen, according to an embodiment herein;

FIG. 31 illustrates an exemplary screen showing promotional offers, according to an embodiment herein;

FIG. 32a illustrates an exemplary screen for updating status, according to an embodiment herein;

FIG. 32b illustrates an exemplary screen showing when the user is the first one to check in at a location, according to an embodiment herein; and

FIG. 33 is a simplified block diagram of a hardware embodiment, according to an embodiment herein.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In this specification and in the appended claims and drawings, “participant,” including grammatical equivalents, singular and plural, means a user who is using the location-based mobile social connection service. The “participant” may be a paying subscriber, a one-time “guest” user, or any other paying or non-paying user of the service who is currently located within a zone.

Mobile Social Connection Tool.

We describe a novel location-based Mobile Social Connection Tool (MSCT) that elevates social applications to the next level by offering a method, system, tool, and service leveraging mobile device technology to facilitate social interaction with other users in a physical setting. The MSCT integrates various technologies in a user-friendly application (app) to easily identify who is available or willing to engage in social interactions in a physical location. It eases that most difficult and embarrassing first meeting, whether in a bar, restaurant, school, airport lounge, or coffee shop.

The MSCT service allows someone to identify other MSCT users in the same location, and determine their social availability, using their readily-available mobile phones. Knowing a person's availability status before you approach someone facilitates and encourages social interactions. And, for those who wish to enjoy an evening out without being approached, the MSCT tool also functions as a convenient, gentle, “keep away” sign, letting others know that you are not interested in conversation.

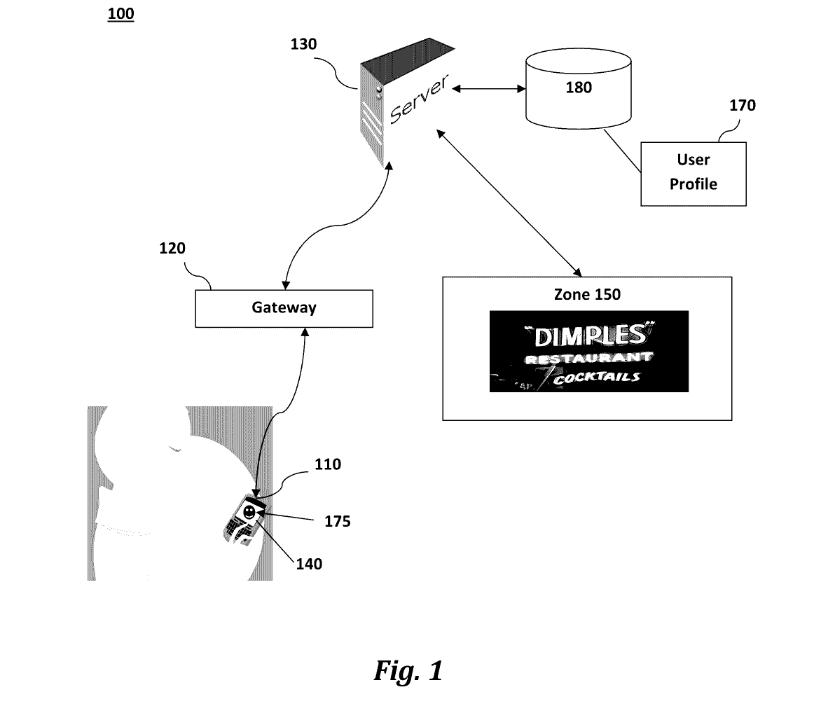

FIG. 1—MSCT System.

Referring now to the drawings in general and to FIG. 1 in particular, there is shown a simplified depiction of a system 100 in which the novel MSCT architecture can be implemented. The system 100 includes a hosting zone 150, server 130, a client device 110, database 180 coupled with the server 130, and a Mobile Application Gateway 120 facilitating communication between the client device 110 and the server 130. The client device 110 can be any wireless mobile computing device such as a cell phone, tablet, personal digital assistant, and the like.

The system 100 can be implemented as follows. A user interested in meeting people joins the MSCT service. Joining the MSCT service can include registering, signing up, and/or or logging in. A user can log in as a registered user or “guest” user. Registering can be easily completed in one of the following ways: through a website hosted by the server 130; by sending a text message to the server 130; downloading the MSCT app on a device 110; or by registering on-site at the MSCT zone 150.

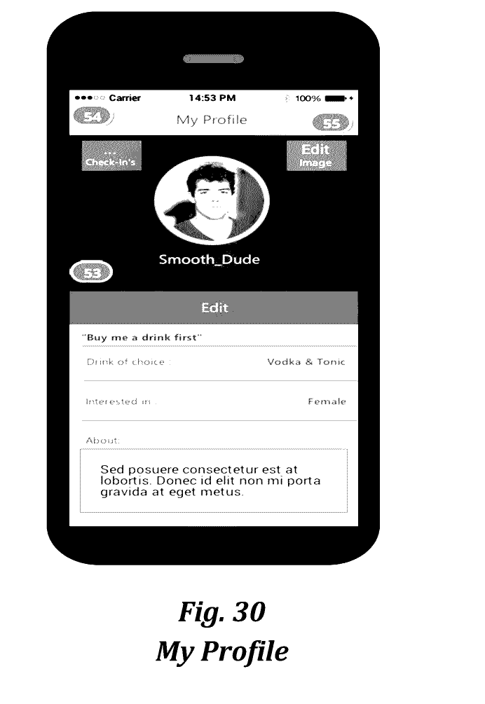

Once signed in, the user provides some personal information that the server 130 uses to generate a user profile 170, which is stored in a data store 180. The user profile 170 can be updated at any time. The personal information is generally limited to “socially relevant” data, meaning generally descriptive parameters such as gender. FIG. 30 is a screenshot of an exemplary profile 170 propagated with socially-relevant information about the user.

The user profile 170 can be viewed by other participants who are registered users of the MSCT app 140 and then only once the registered user has checked-in to the zone 150. Once checked-in to a zone 150, a registered user can see the user profiles 170 of other participants who are checked-in at the same zone 150. The zone 150 in FIG. 1 depicts a restaurant and bar. This is one possible embodiment of a zone 150.

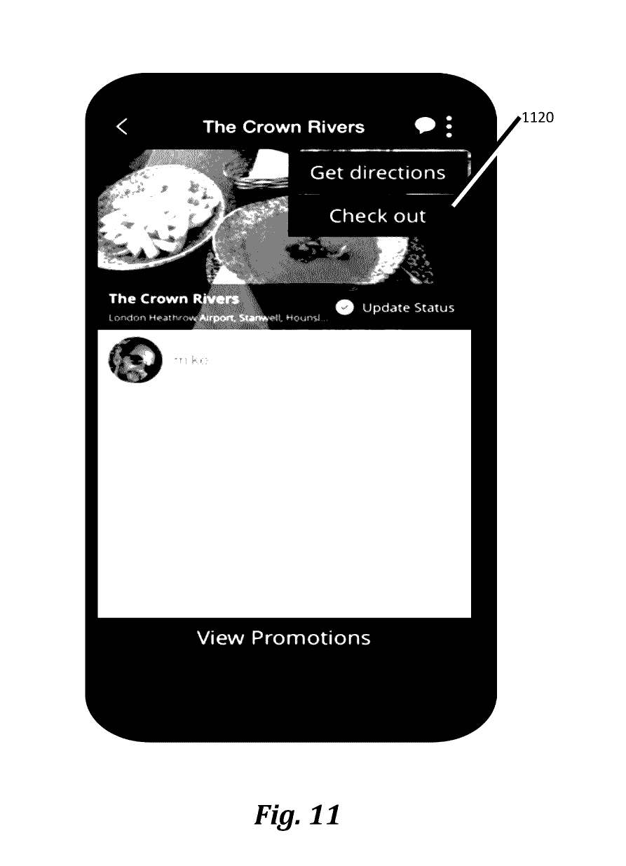

Referring now to FIG. 8, there is shown a check-in screen 720 showing a listing of MSCT zone users currently checked-in at the zone 150 selected by the user. Prior to check-in, the social status 170 of other users in the zone 150 is not revealed. In one embodiment shown in FIG. 8, the social status “dot” indicators 175 are shown grayed out until the user checks in. In order for the user to see the social status 175 of other participants and further to view their profiles 170, the user must check-in to that zone 150. Once checked-in, the social status indicators 175 of other users in the zone 150, which in this example are colored dots, are revealed as shown in FIG. 11.

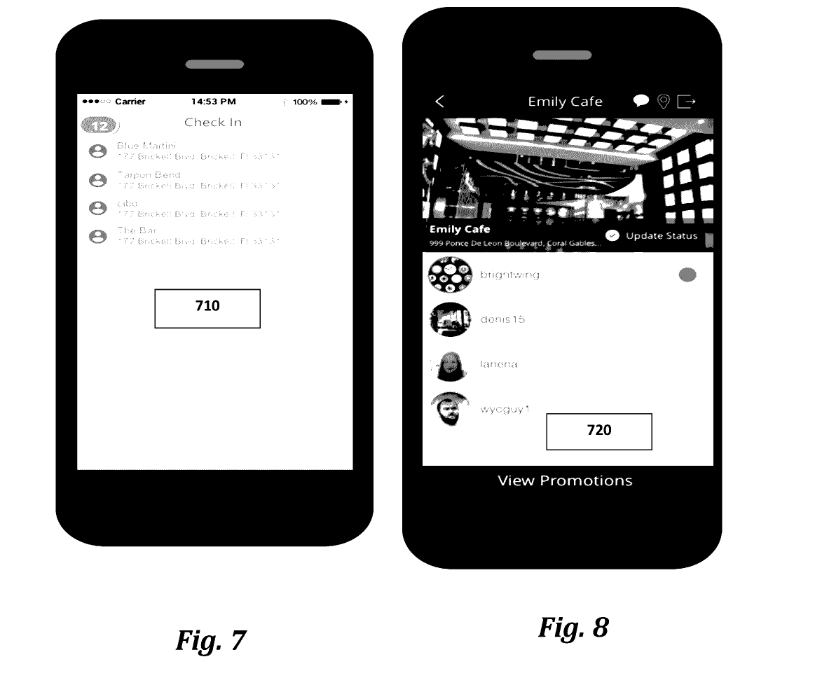

With the MSCT app 140 activated on the client device 110, the user can check-in to any MSCT zone 150, which can be a restaurant, bar, or other locale hosting the MSCT service, as long as the user is physically located within (or in close proximity to) that zone 150. An MSCT “premium zone” is a zone 150 that pays a fee for the service and often provides special benefits to registered users. FIG. 7 shows one example of a check-in screen 710. This check-in screen 710 lists the MSCT zones 150 which are near the user's current location, as derived from the mobile device 110 location. In this example, the user simply selects a desired zone 150 (proximate to the user) to initiate the check-in process. Once the zone 150 is selected, the next check-in screen 720 shown in FIG. 8 is a confirmation of the selected zone 150 wherein the user simply selects the “Check-in” field. In an embodiment of the invention, “VIP access” will allow users to identify themselves as a MSCT user, prompting the MSCT premium zones to give them VIP access to the zone 150. Some examples of VIP access are: not waiting in line; discount in bottle service; access to private areas; special drink discounts, and the like.

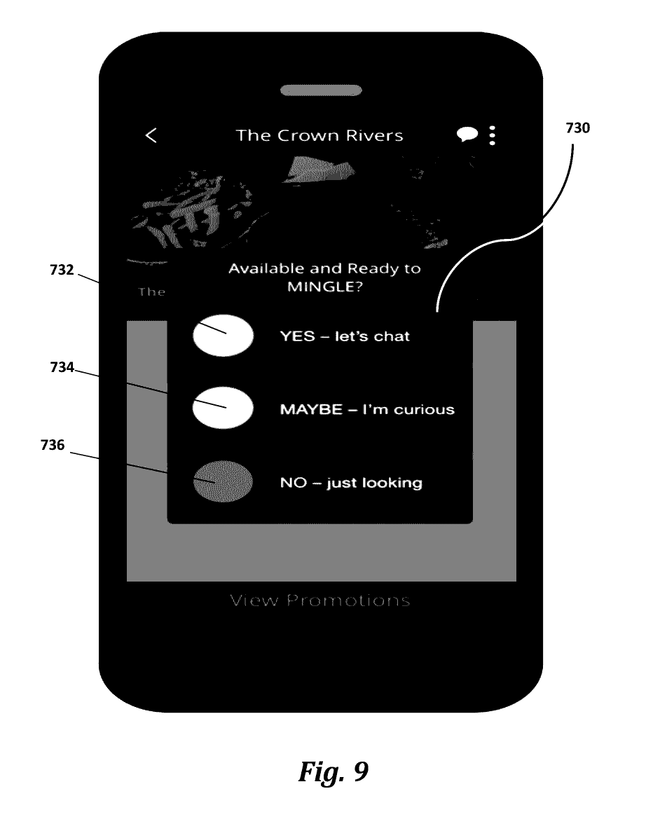

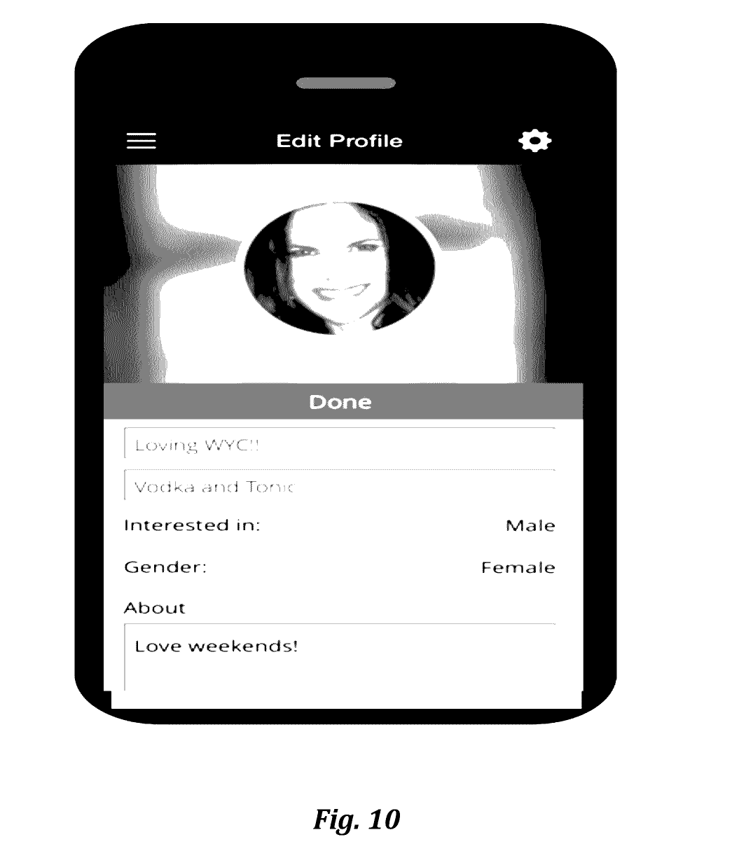

As part of the check-in process, the user is prompted to select a current social status 175. FIG. 9 provides one example of a user interface 730 for indicating a social status 175. In this example, a pop-up window 730 prompts the user to select from three radio buttons in different colors. The green radio button 732 indicates a willingness to socialize. A red radio button 736 indicates that the user is currently not willing to engage with anyone at this location. A yellow radio button 734 indicates a willingness to socialize without any intent to form a relationship.

The MSCT service is a location-based service and the act of checking-in provides the user's location to the MSCT server 130. The user's location is provided to the server 130 via a wireless access point (WAP) or a mobile device feature using known positioning technology such as GPS (global positioning system). The server 130 continuously monitors the various zones 150 and the registrant's locations with respect to the zones 150.

Checking-in, from the user's perspective, can be as simple as selecting a “Check-in” icon on the device 110 as shown in FIG. 8. This sends a communication to the server 130, providing the user's current location. Once the user activates the “check-in,” the MSCT app 140 prompts the user to provide his/her willingness to socialize (social status) via the app 140, as shown in FIG. 9. This is easily done by selecting a graphical image such as an icon 175. Once checked-in, the MSCT app 140 provides the social status and user profiles of other registrants who are currently in the same zone 150, as shown in FIG. 11.

Now that the user is checked into the zone 150, the MSCT app 140 provides some basic details about any other registrants who are also in the zone 150 (and have checked-in). The basic details can include a name or nickname (provided by the user when registering), along with the social status icon 175. In this manner the MSCT user is able to easily determine who, if anyone, in the MSCT zone 150 is available for social interaction. This makes approaching someone so much easier and less embarrassing because you already know the other person's willingness to meet. Given that so many people rely on their mobile phones for interaction, this will be one other tool for people to enrich their social experience.

The social status icon 175.

A person's availability to engage in a social interaction or meet that specific day, in that specific location or zone 150, can be easily communicated through a graphical image, such as a color icon 175. For example, in the United States and other countries, many people are conditioned to think of the colors green, red, and yellow as representing the concepts “Go!,” “Stop!,” and “Slow!,” respectively. We take advantage of this inclination and propose a green icon 732 to indicate a ready willingness and availability for all social interactions, such as meeting people, conversing, and mingling. A yellow icon 734 can be used to indicate a somewhat less available status. Someone selecting a yellow icon 734 might be married or in a relationship but that specific night, and in that specific location, the person is willing to converse or meet new people. A red icon 736 can be used to indicate a lack of interest in social interaction. A person selecting a red icon 736 simply wants to spend time in a location without interacting with anyone. Selecting this icon 736 limits a participant's ability to interact (can't send messages), but the participant can still view the other participants in the zone 150 and easily determine their social status 170.

The participant can change his/her color an unlimited number of times depending on mood, circumstance, day, people present in the zone 150, and so forth. Colors are set based on the criteria selected by the user. Since this is a variable of each interaction, users can choose either one of three colors, depending on their mood.

In other embodiments, the user's current social inclination can be identified by graphical images 175 other than color icons. For example, it is contemplated that emoticons, flags, symbols, and other images can be used to signify social status. The images can be selected by the user on the MSCT app 140. The graphical images 175 can be customized with, for example, a team image in the center of the color icon.

User Profile 170.

The User Profile 170 is stored in the data store 180 and can contain the following socially relevant data about the user:

1) nick name or name;

2) a photo;

3) favorite drink;

4) social status such as a color: red, yellow, green to designate your availability and level of interest in meeting someone.

It should be noted that a profile 170 and the data it contains is tied to the level of use. For example, a registered (paid) user will be prompted to set up a profile 170 whereas a “guest” user does not have that option. A guest user is a user who has not registered with the MSCT tool but wishes to try the service on a temporary basis. In this case, a guest user does an “express check-in” without a profile. The app 140 will then request some basic information and social status 175 and generate a modified profile 175. Other embodiments for registering as a user may include entering data into form fields, or by pulling user data from other social network profiles (such as Facebook) through a data connection to a user's social media account. For example, this may be accomplished by using a “Login using Facebook” prompt.

MSCT Zone 150.

As previously stated, an MSCT Zone 150 can be a restaurant, bar, airport lounge, mall, coffee shop, or any other locale where people are likely to spend time. When requested, the MSCT service can provide a list of zones 150 that are in proximity to the user. Known geo-location tools are leveraged to make this possible, such as Google Maps®. MSCT Premium zones will appear first in the list of locations (and will feature the MSCT logo beside the name on the search results listing). To be listed as a MSCT premium zone, the location will have to pay a monthly subscription fee. In exchange, the premium zone will appear first in the list of locations and it will be able to offer promotions to MSCT customers (drinks, special events, and the like).

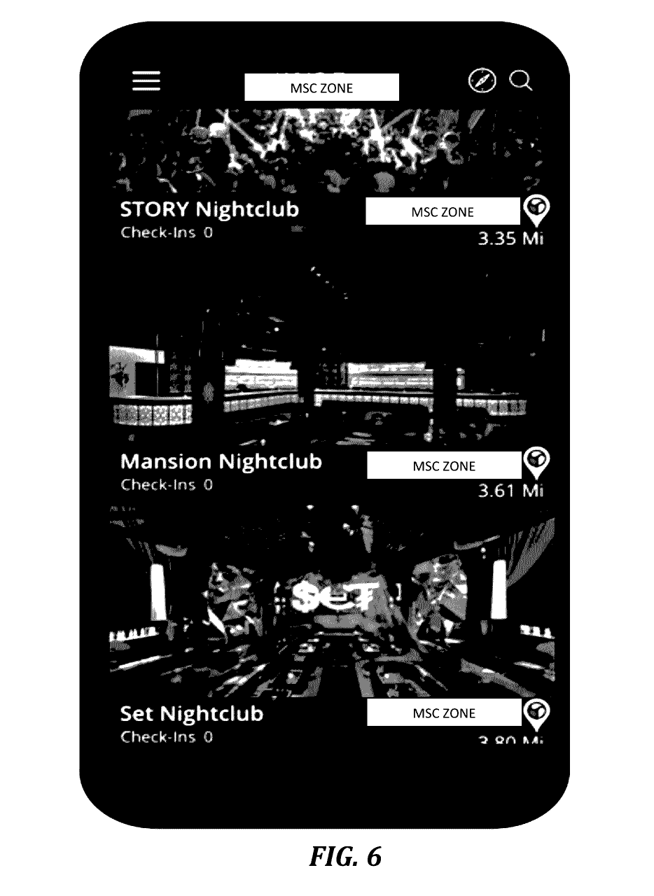

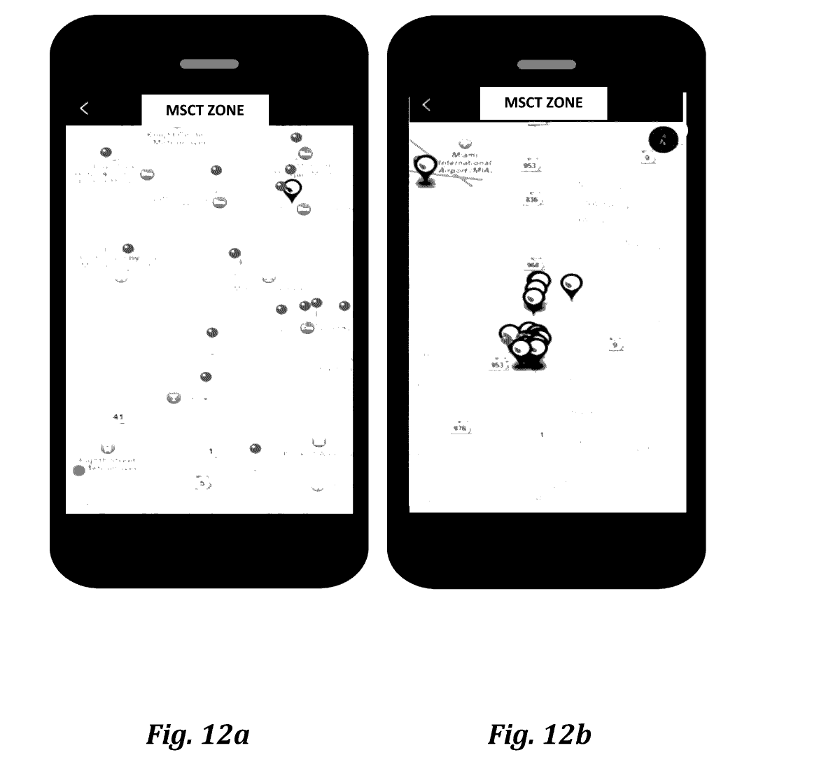

The list of zones 150 can be provided as a listing, as shown in FIG. 6 or in a map view, as shown in FIG. 12. The app 140 will perform under the following conditions:

1) MSCT Zones 150—The app 140 will let you know that you are close to a MSCT premium zone;

2) User can voluntary check-in.

MSCT App 140.

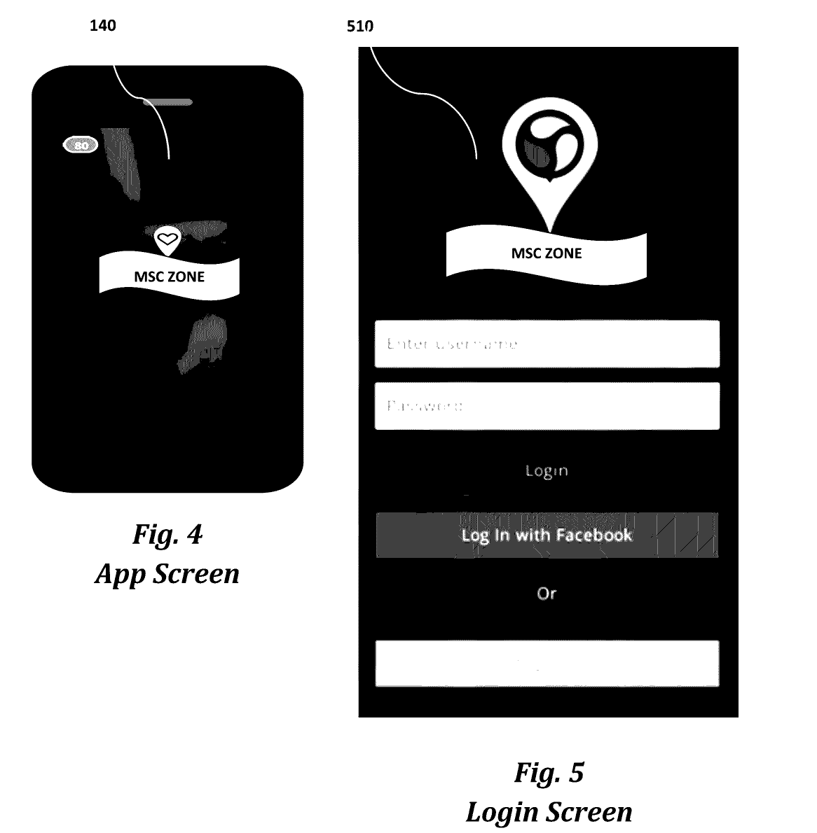

It is contemplated that the MSCT tool will be implemented as a mobile app (application) 140, according to an embodiment of the present disclosure. A mobile app is a software program that a user downloads onto a mobile device 110. Referring now to FIG. 4, the mobile app 140 is accessed directly from the mobile device 110, usually by selecting the mobile app icon associated with the app. Currently there are two types of mobile apps, native apps and mobile cloud apps.

A native app is installed directly on the mobile device and different versions are often made, dependent on the mobile device developer. For example, many people today are very familiar with Apple® apps for iPhone®, as well as Android® apps for Samsung® phones. Data associated with a native app can be stored in the device or stored remotely and accessed by the native app. Because native apps use device-specific hardware and software, they are able to interact with in-device features and apps such as a global positioning system (GPS), short messaging service (SMS) app, sound, and a built-in camera.

Mobile cloud apps are more similar to Web-based applications because they run on servers external to the mobile device 110 and require the use of a Web browser. Because the mobile cloud app is Web-based, users do not need to download the mobile cloud app. A mobile cloud app can access in-device features through the use of an application programming interface (API).

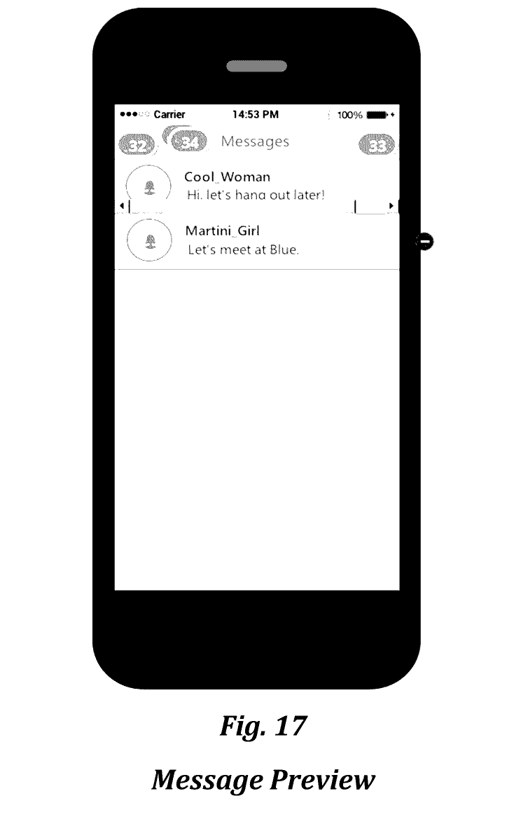

The MSCT mobile app 140 can interact with other mobile apps and in-device features such as SMS, GPS, sound, camera, and the like. One of the elements of the MSCT tool, whether embodied as a mobile app 140 or otherwise, is the chat feature which leverages messaging technology available on mobile devices to send and receive messages while checked-in at a zone 150. FIGS. 17 through 19 provide examples of the chat feature.

FIG. 19 provides an example of the wink feature, while FIG. 29 provides an example of a wink confirmation.

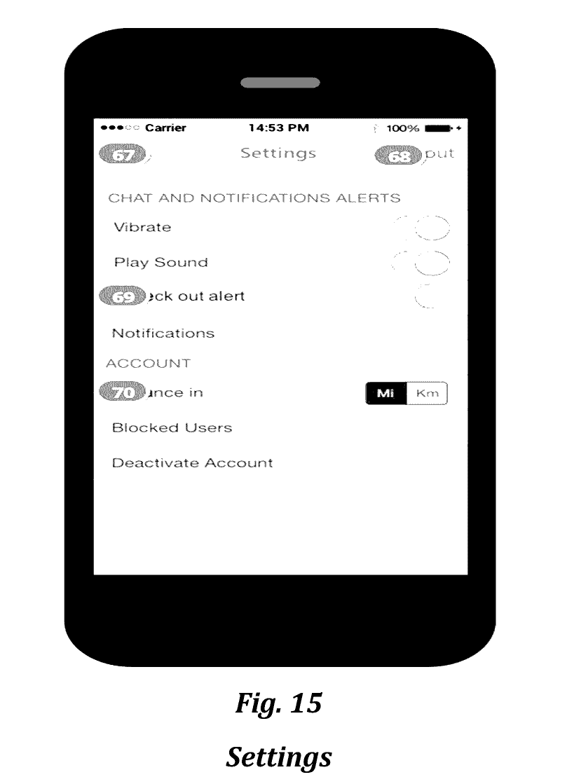

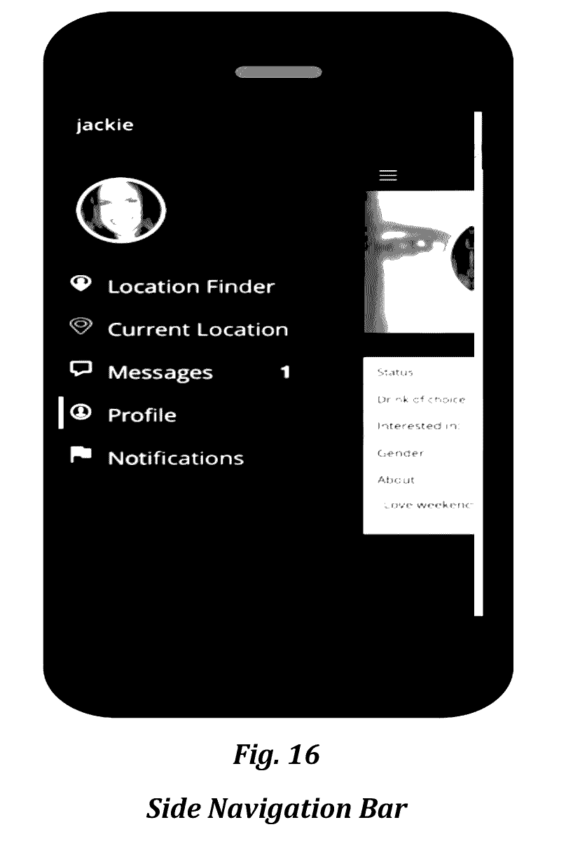

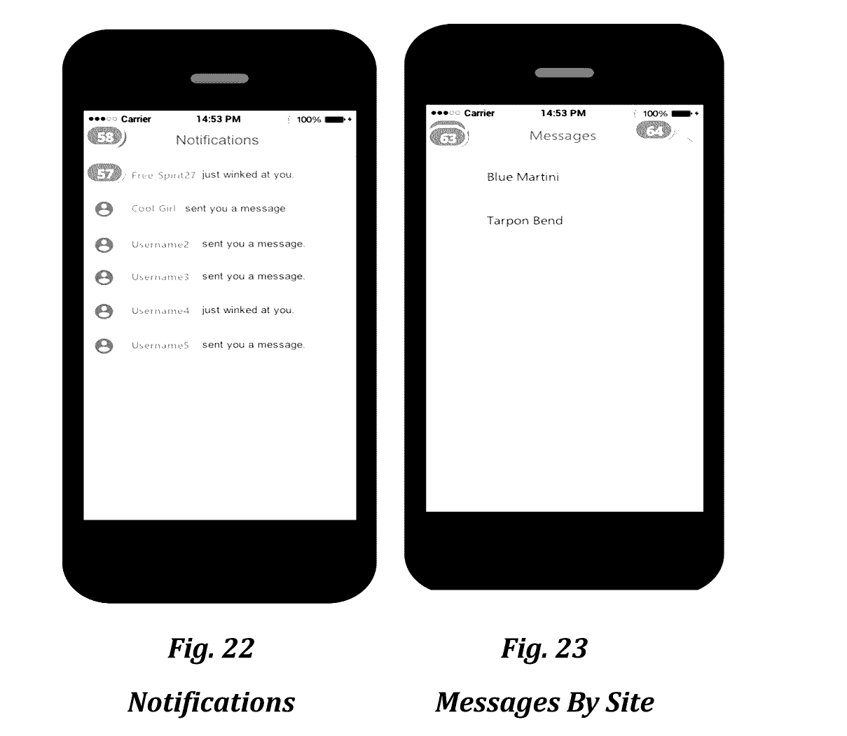

The MSCT app 140 can be easily customized via a Settings screen as shown in FIG. 15. FIG. 15 shows some possible parameters that can be set by the user. FIG. 16 illustrates an example of a side view navigation bar for scrolling through the various options. For example, the app 140 provides notifications of social interactions prompted by other participants within a zone 150, an example of which is shown in FIG. 22. FIG. 23 provides an example of message notifications by zone 150. FIG. 25 provides an example of how easily push notifications can be enabled on the client device 110.

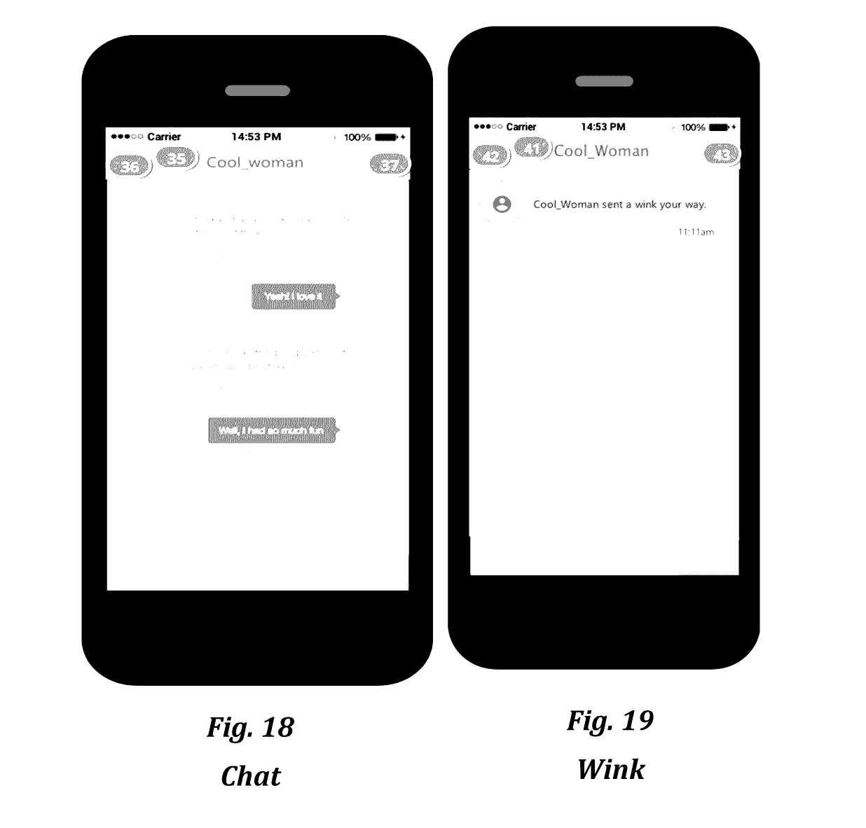

FIG. 17 provides an example of a message preview screen, showing a preview of messages to/from participants. FIG. 18 provides an example of an on-going chat session. Embodiments of the invention including a chat system can utilize the Extensible Messaging and Presence Protocol (XMPP) technology. XMPP is an open standard protocol that provides a general framework for messaging across a network. Embodiments of the present invention utilizing XMPP do not use Short Message Service (SMS). The XMPP chat server application is installed on the application server 130 and is used to check online/offline status of users and relay messages appropriately. In embodiments of the present invention utilizing XMPP, message content is not stored on the server 130, rather, messages are merely relayed to the appropriate location/device 110.

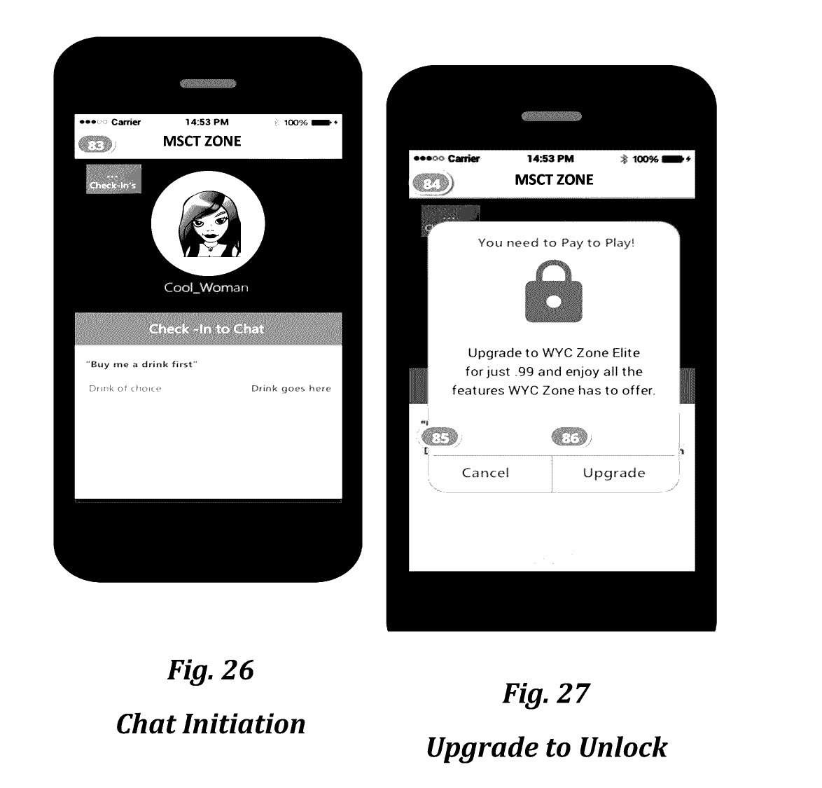

FIG. 26 provides an example of how a user might initiate a social interaction with another participant. In this example, the user is interested in interacting socially with “Cool Woman.” Before he/she can interact with this participant, however, the user must check-in. This check-in process is the same as when a user checks-in to a location and need only be completed once at a location for a single visit.

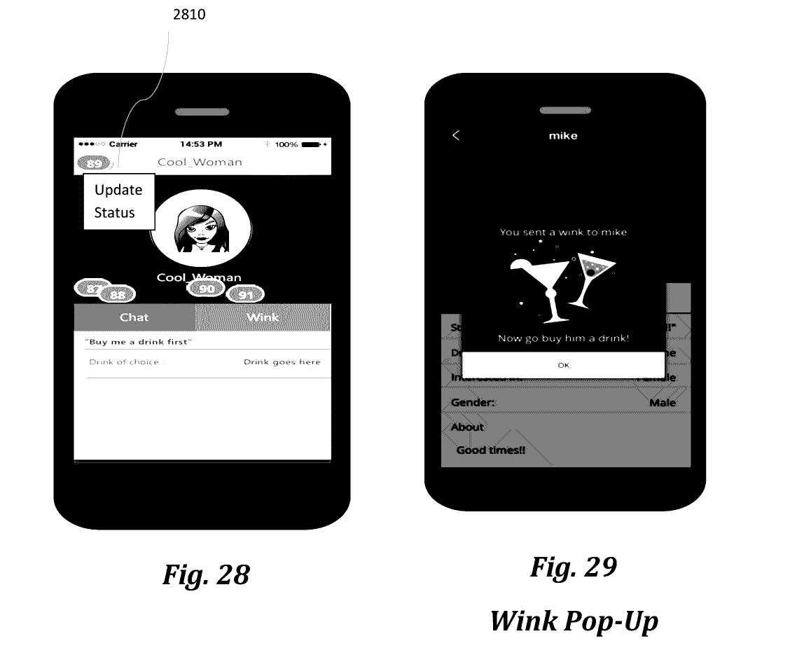

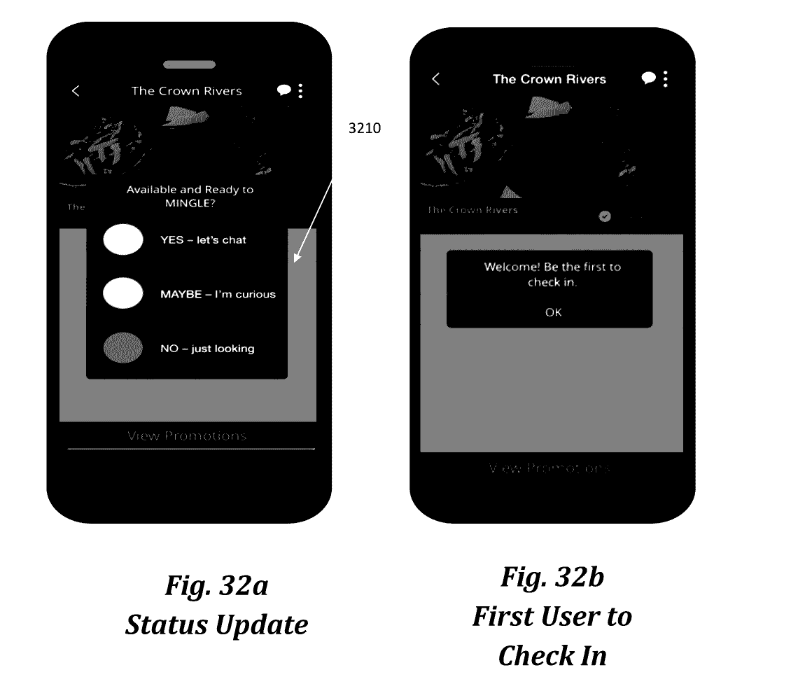

Users are required to check-in to a location in order to interact with other users via the application. The process of checking-in enables certain features of the MSCT app 140, such as communication with other checked-in users. Once a user is checked-in to a location, the “check-in” button transforms into an “Update Status” button 2810, as shown in FIG. 28. Once selected, the “Updated Status” button 2810 triggers the “Update Status” pop-up window 3210 shown in FIG. 32a. One with knowledge in the art will appreciate that the “buttons,” “pop-up windows,” and other GUIs depicted in the drawings are exemplary representations of user interaction tools and are not meant to be limiting in any way. In certain embodiments, the MSCT app 140 will feature alternative user interaction tools and still remain within the spirit and scope of the disclosure.

Note that the screen in FIG. 28 not only shows the participant's user name “Cool Woman,” but also the user's photo, catch-phrase “Buy me a drink first” and her drink of choice. Once checked in, the app 140 enables the “chat” and “wink” features as shown in FIG. 28. FIG. 28 provides one example of how easy it is to interact with a participant, using the MSCT's proprietary user interface. In FIG. 29 we assume that the user has selected to “wink” at “Cool Woman” and this wink confirmation is displayed. Note that the wink feature is only enabled after check-in.

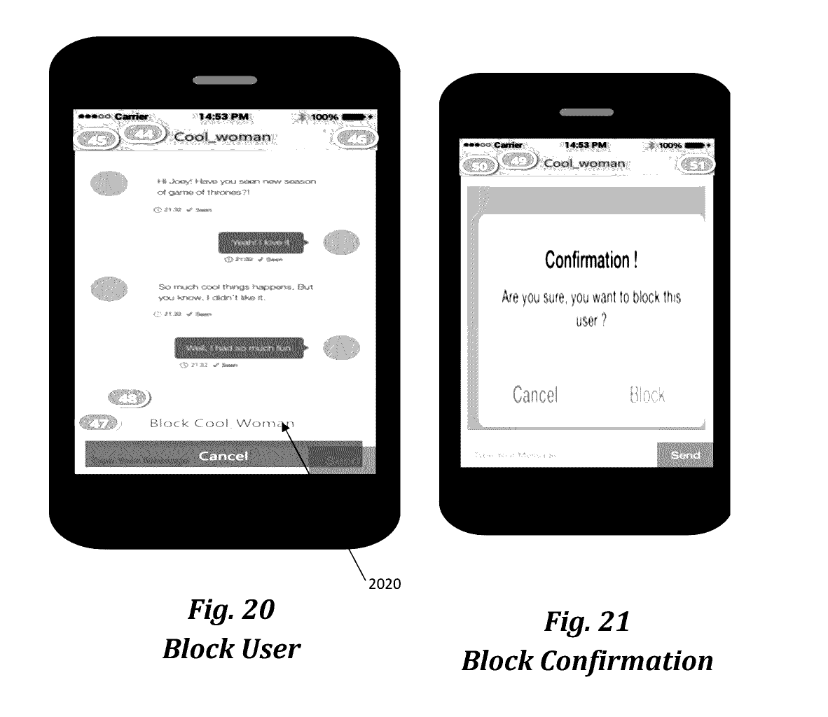

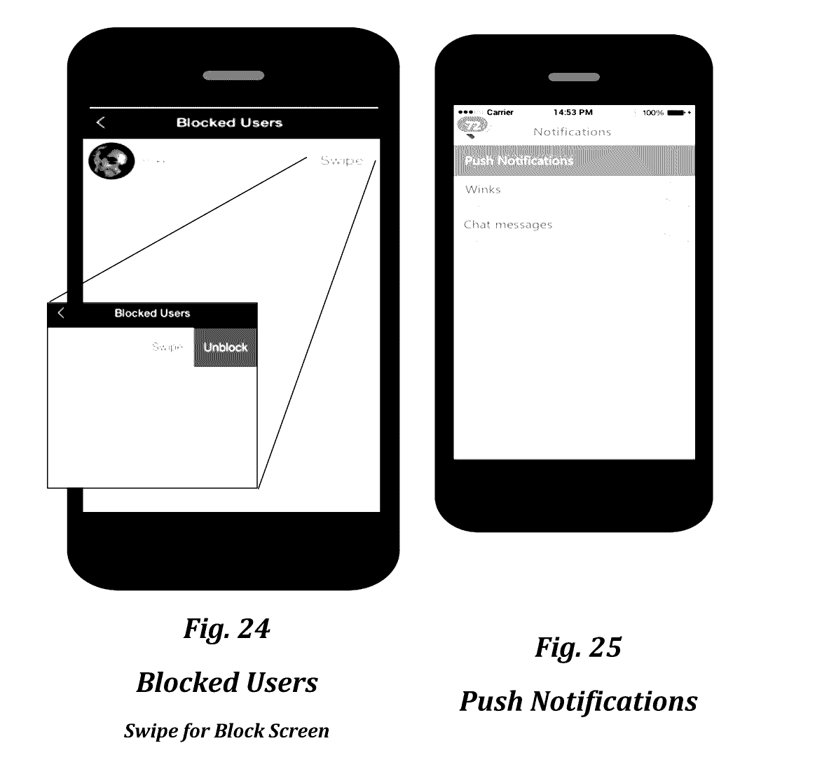

Referring now to FIG. 20, another available option is the ability to block another participant from communicating with you. To block another user, you access that user's profile and press the block button 2020. Accessing the user's profile is easily done by selecting the user's icon. For example, FIG. 11 shows a list of users in the zone 150. Accessing “Cool Woman's” profile is done by selecting her icon. After initiating the block command, confirm that you want to block that user (see FIG. 21) and communication between your two accounts ceases. To unblock a user, go to “My Profile” and click on “Settings.” Next, click on the Blocked Users list, and swipe a user to show the “Unblock” button (FIG. 24). FIG. 20 provides an example of how easy it is to block a participant from interacting with you. Once the block has taken effect, a block confirmation is provided, an example of which is shown in FIG. 21. Unblocking a participant is easily done, as shown in FIG. 24.

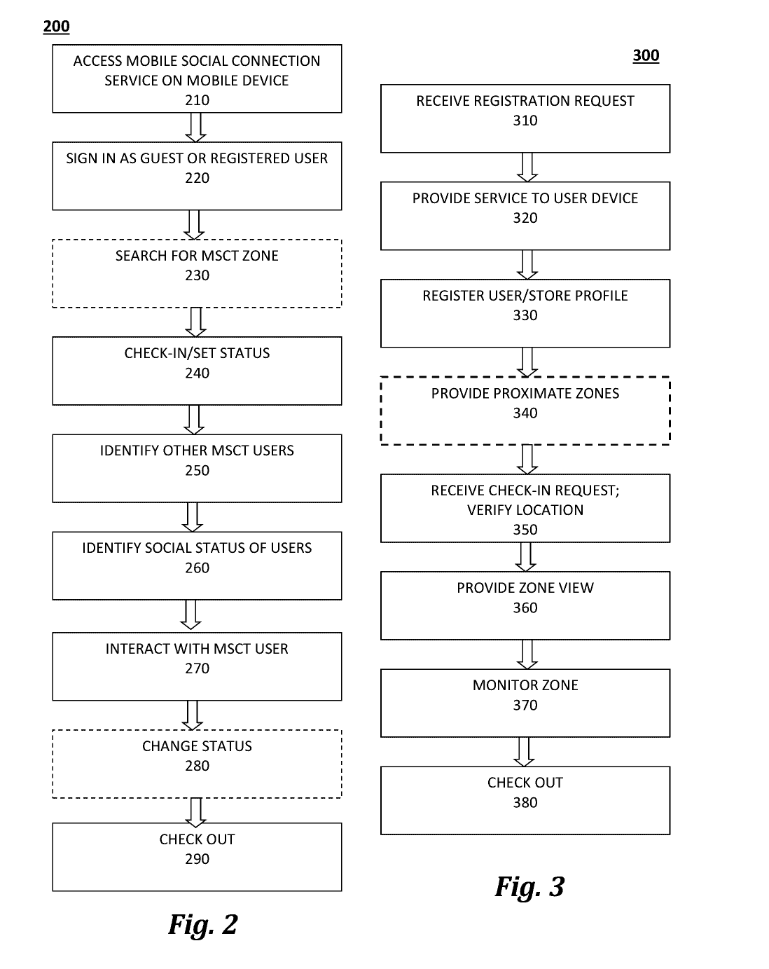

Flowchart FIG. 2.

Referring now to FIG. 2, there is illustrated a flowchart 200 of a method for socially connecting by location, according to an embodiment of the present disclosure. In step 210, a user accesses the MSCT service on his/her mobile device 110 by download from a Web server, installation from a storage medium, or other access methods. The MSCT service can be provided for free or for a fee. The MSCT zone 150 may provide the service for free as part of an effort to entice patrons to spend time (and money) there, much the same way that many establishments now offer free Wi-Fi services.

Once the MSCT service has been made available to the user, the user then provides some basic, socially-relevant data in step 220. By following on-screen prompts, the user is able to provide identifying information such as a name or nickname, gender, hobbies, interests, and other identifying information, such as your favorite drink, your alma mater, favorite team, and the like, which the server 130 uses to propagate a user profile 175. At a minimum, the user must provide a name or nickname. The user will also provide a photo to associate with his/her profile 170. The photo can be provided by conventional means, such as by uploading.

Now with the MSCT app 140 activated on the user's mobile phone 110, the user can search for a MSCT zone 150 in step 230. Note that this step can be skipped if the user is already in a MSCT zone 150.

In step 240 the user enters the MSCT Zone 150 and checks-in. Checking-in, as used in this disclosure, provides the user's location information to the server 130. The server 130 in turn provides the user names for all of the registrants currently located in the MSCT zone 150. The check-in works both ways. Not only does the user make his identity known to others, but the others are also receiving information that the user is now in the zone 150.

Also, as part of the check-in process, the MSCT user selects a graphical image (icon) 175 that identifies the user's current social inclination. As an example, in one embodiment of the present disclosure, color icons 175 are used to identify the user's current social inclination. In order to simplify the examples provided in this disclosure, and without limiting the invention to these examples, or to just three icons 175, we will use GREEN, YELLOW, and RED to signify social inclinations, where GREEN indicates an eagerness to socialize, YELLOW indicates a limited willingness to meet people, and RED indicates no willingness to socialize in this venue at this time. Note that a person's social status of GREEN, YELLOW, or RED only indicates that person's social inclination at that place and time and it can easily be changed.

In step 250, the MSCT app active on the user's mobile device 110 presents other MSCT users in the same zone 150. Based on the color associated with the other users, the user will be able to identify if a person is available to talk or not. Likewise, other MSCT users will see that the user's social status. In step 270, the user can engage in an interaction with another MSCT user. The interactions can be a “wink,” a greeting, or a message (chat). In optional step 280, the user changes his/her social status indicator 175.

In step 290, the user is checked out of the zone 150. This can work in one of two ways: automatic and express. The MSCT app 140 constantly monitors the location of the user once the app 140 is initiated and the user has checked in, perhaps with intervals of 15-30 seconds. Tracking the user's location is facilitated by customizing application program interfaces (APIs) such as Google Places® and other geo-location tools on the mobile device 110. When the user moves away from the coordinates designated as the zone 150, then the app 140 automatically performs a check-out of the user.

In addition, the user can initiate an express check-out by selecting the check out field 1120 as shown in FIG. 11. A user may wish to expressly check-out while remaining in the zone 150 so that the user's status 175 and profile 170 are hidden. By checking out, the user also forfeits any interactions through the app 140. For example, one cannot chat with, wink at, or greet others in the zone 150 (through the app 140) unless you are in “checked-in” status. The person with whom you wish to communicate must also be in “checked-in” status, either as a registered user or as a guest user.

Flowchart FIG. 3.

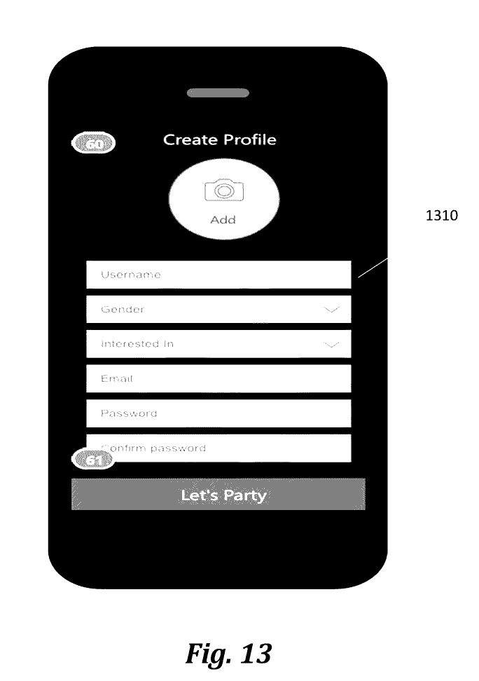

Referring to FIG. 3, there is shown a high-level flowchart 300 of the server-side processing implemented by the MSCT service, according to an embodiment herein. In step 310, the server 130 receives a request from a user device 110 seeking to access the service, either as a registered or “guest” user. The request can be a request to download the MSCT app 140 on the user's device 110. Once the user has access to the app 140, the user is prompted to register for the service by providing some information, as shown in FIG. 13. In this screen 1310 the user fills in some required information such as username and interests, and selects a password. Some of this information will be used to propagate the user profile 170. The user can also provide a photograph.

In step 320, the MSCT service is provided to the client device 110 either by download or other means. Next in step 330 the server 130 receives and stores the information provided by the user in a user profile 170.

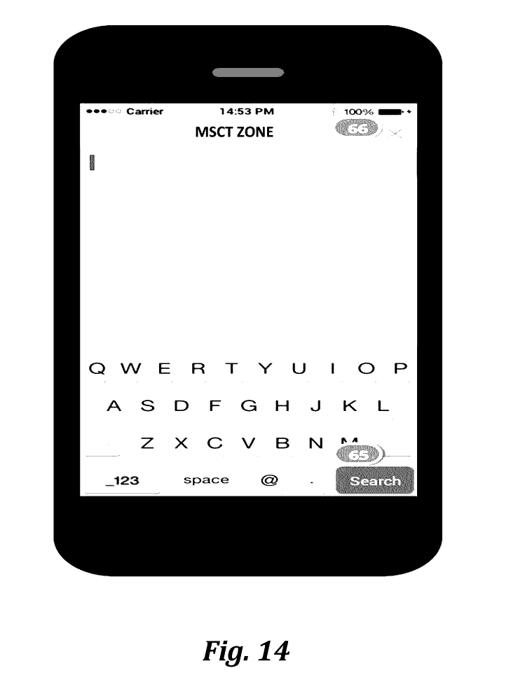

Step 340 is only carried out if/when the user initiates a search for MSCT zones 150 in the user's area. A user can initiate a search by using a proprietary search interface such as the one shown in FIG. 14. The server 130 determines the user's current location and provides a view of the local zones 150. The view can be a map view as shown in FIG. 12. Alternately, the view can be a list as shown in FIG. 6.

At some point, the server 130 receives a check-in request from the mobile device 110 once the user has arrived at a zone 150. The check-in request indicates that a registrant has entered a zone 150 and wishes to know what other registrants are also there, and also wishes to view their social status 175. The server 130 verifies the device's location, and in step 360 provides a “zone view.” A zone view is a list of all registrants currently in the zone 150, along with their up-to-date social status icons 175. FIG. 11 provides an example of a zone view. As previously stated, a user can update his/her social status at any time. It is possible that a user may wish to change his/her social status depending on the social status of other participants. The zone view as shown in FIG. 11 provides the user with an indication of how many and who are willing to socialize and this information may prompt the user to update his/her social status.

Once a registrant completes the check-in process, the server 130 confirms the checked-in status of the registrant and continues monitoring the user's activity within the zone 150 in step 370. The monitoring also includes monitoring of the user's location. As previously stated, once the user leaves the zone 150, he/she is checked-out in step 380.

Monetization.

In one embodiment of the present disclosure, the MSCT service is provided for a one-time fee or as a subscription service. It is contemplated that restaurants, bars, coffee shops, and the like (the zones) will pay to provide this convenience to their customers, in much the same way that many coffee houses now provide free Wi-Fi.

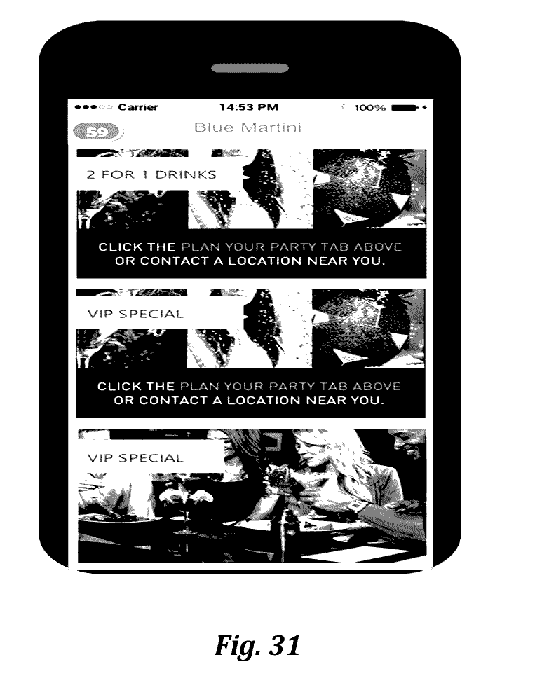

In agreeing to provide the service for free to patrons, the MSCT Zone 150 can monetize the effort by serving advertisements along with the app 140. The advertisements will attract people to visit the zone 150 and spend money. Some examples of advertisements are announcements for Happy Hour, Ladies Night, special events, and the like. An example is shown in FIG. 31.

The price for the service can be increased for an upgraded account. An upgraded account provides more features for the user, such as a view of the checked-in participants in other zones 150. FIG. 27 provides an example of an upgrade screen.

### Hardware Embodiment

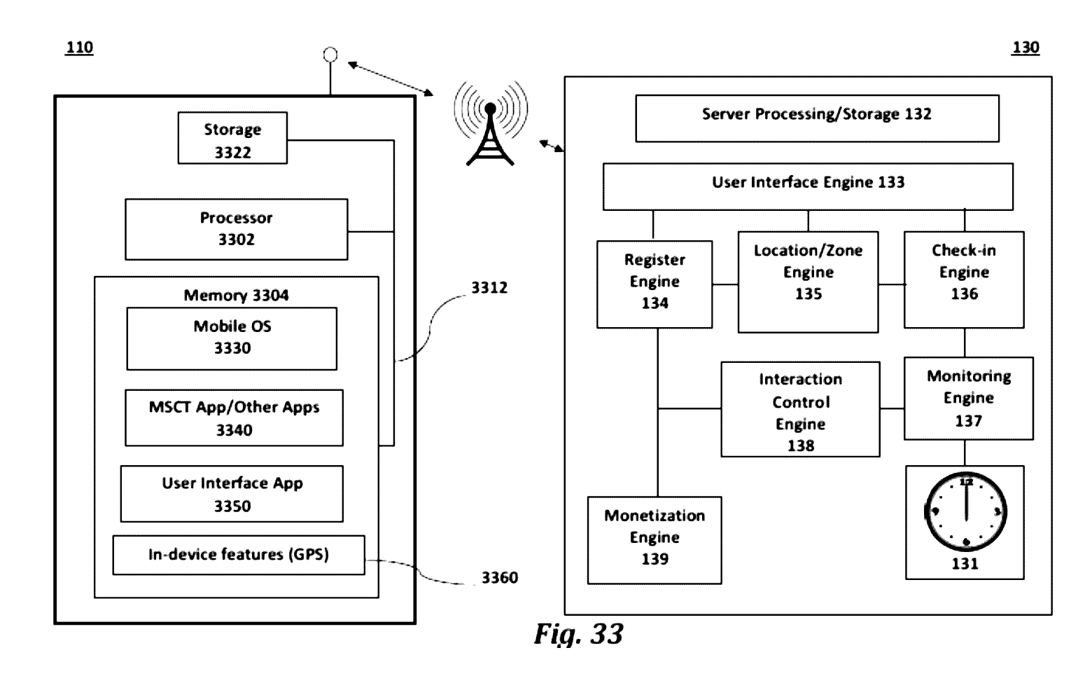

Referring now to FIG. 33, there is provided a high-level block diagram of the client-side and server-side hardware components for implementing the MSCT, according to an embodiment of the present disclosure.

Client-Side 110.

The client device 110 may represent any type of mobile programmable electronic device, such as a smartphone, wearable computing device such as the Apple Watch®, tablet computer, personal digital assistant, laptop computer, and the like. The client device 110 can include a processing device 3302 coupled with memory 3304, storage 3322, and in-device features such as GPS 3360, all operatively linked by bus 3312. One with knowledge in the art will appreciate that other components will be included in order to operate a commercially feasible device; however these are not depicted herein for simplicity and clarity of illustration.

The client device 110, in its embodiment as a mobile device, includes a Mobile Operating System (OS) 3330 which can be a proprietary OS developed and sold by a provider, such as iOS developed by Apple Inc., and Android OS developed by Google. The Mobile OS 3330 contains operating system features, in addition to other features 3360 common to smartphones, such as GPS, camera, music player, Bluetooth, and the like.

The Mobile OS 3330 will also include various apps 3340, some of which are supplied “out of the box” (included with the device 110), and some of which are later acquired by the user. The apps 3340 can include, for example, XMPP, GPS, and the like. Future marketing and development will decide in which manner the MSCT app 140 will be provided. The User Interface App 3350 is what determines how the user interacts with the device 110. The User Interface App 3350 determines the “look and feel” of the various apps 3340 and controls such things as touch screens, swipes, icon views, and the like.

Server-Side 130.

The Server 130 is a computing system which can be a stand-alone computer or networked into a larger system. For purposes of this disclosure, the Server 130 is a networked computing device in communication with other network devices. It will be readily appreciated that the Server 130, as a computer, includes conventional hardware and functionality required to operate as a MSCT provider. This hardware and functionality are well known to those with knowledge in the art and thus are simply represented in the diagram as Server Processing/Storage components 132.

The User Interface Engine 133 provides the MSCT graphical user interface with which the user of the service engages. Interaction between the user and the MSCT service is directed by the User Interface Engine 133, such as providing screens, receiving input, providing pop-up windows, and the like. The user interface processing is preferably performed using technologies such as Java-based graphical user interface technologies, although other similar technologies now known or subsequently developed may be used for the processing.

The Register Engine 134 handles the user registration and interfaces with the Monetization Engine 139 for processing any fees or upgrades attached to the registration. The Register Engine 134 also builds the user profile 170.

The Location/Zone Engine 135 provides zone 150 information and processes the client device location. The Check-in Engine 136 handles all of the check-in procedures, including assigning a social status to a participant. The Monitoring Engine 137 is called by the Check-in Engine 136 once a participant checks into a zone 150. The Monitoring Engine 137 continuously monitors all checked-in participants and all activity within the zones 150. The Monitoring Engine 137 uses a timer 131 to perform “presence” tests to determine if a participant is still located within a zone 150. The “presence” tests are performed at pre-determined intervals, perhaps every 10-30 seconds until a participant is checked-out of a zone 150. Once a participant is checked out of a zone 150, that participant is no longer monitored.

The Interaction Control Engine 138 is called by the Monitoring Engine 137 to enable/disable any interaction between participants, depending on social status or on the participant's registration status. For example, a participant who has selected a social status indicating no desire in social interaction (Red button) cannot send or receive messages and/or winks. Interaction can be further restricted and/or upgraded by the participant's registration level. For example, a participant with a premium upgrade will be allowed a greater degree of interaction. The Monetization Engine 139 handles the payments and advertising placement.

Therefore, while there has been described what is presently considered to be the preferred embodiment, it will be understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

1. A computer-implemented location-based mobile social connection method comprising steps of:
providing a mobile social connection tool comprising a graphical user interface on a client device associated with a first user, said mobile social connection tool facilitating user interaction with a location-based mobile social connection service hosted by a server;
configuring the server to interact with the client device through the graphical user interface, said configuring comprising:
configuring a user interface engine to receive:
input comprising socially relevant data from the first user; and
a check-in request from the first user while said first user is present in a zone participating in the location-based mobile social connection service;
configuring a check-in engine to provide a check-in screen to the mobile social connection tool upon receiving the request, wherein providing the check-in screen comprises providing a social selection tool whereby the first user selects a social status indicating said first user's current willingness to socialize while in the zone;
configuring an interaction control engine to receive the social status from the first user;
using the check-in engine operably coupled with the interaction control engine, checking in the first user to the zone, said checking in comprising:
revealing the social status and the socially relevant data of the first user to other participants in the zone where said first user is currently checked in;
providing the social status and the socially relevant data of other participants in the zone where the first user is currently checked in; and
enabling/disabling social interaction among participants in the zone, depending on the social status selections and check-in status; and
configuring a monitoring engine to monitor a continued presence and the social status selections of participants in the zone.

2. The computer-implemented method of claim 1 further comprising:
receiving a request from the first user to locate a zone within proximity to the first user's client device;
receiving a location of the first user's client device; and
configuring a location/zone engine to provide a location of an at least one zone that is in close proximity to the location of the first user's client device.

3. The computer-implemented method of claim 2 wherein providing the location of the zone comprises providing a map view of said zone.

4. The computer-implemented method of claim 2 further comprising providing a count of participants currently located within the zone.

5. The computer-implemented method of claim 1 wherein providing the social selection tool comprises providing:
a first selectable graphical image representing a high willingness to socialize with the other participants in the zone;
a second selectable graphical image representing a limited willingness to socialize with the other participants in the zone; and
a third selectable graphical image indicating no willingness to socialize with the other participants in the zone;
wherein the first, second, and third selectable graphical images are visually distinguishable from each other such that the social status is easily identified.

6. The computer-implemented method of claim 5 further comprising providing the first, second, and third selectable graphical images as radio buttons in different and distinct colors.

7. The computer-implemented method of claim 5 further comprising providing the first, second, and third selectable graphical images as icons in different and distinct images.

8. The computer-implemented method of claim 1 wherein monitoring the continued presence and social status comprises:
continuously monitoring the location of a checked-in participant by querying a positioning tool of the client device; and
checking out the checked-in participant from a zone when said checked-in participant is determined to have left said zone.

9. The computer-implemented method 1 wherein receiving the input comprising socially relevant data comprises:
configuring a register engine to register the first user with the location-based mobile social connection service;
propagating a user profile with the input provided by the first user, said input selected from a group consisting of: a name, a nickname, gender, age, hobbies, interests, beverage of choice, marital status, likes, and dislikes; and
storing the user profile in a data store associated with the server.

10. The computer-implemented method of claim 1 further comprising configuring a monetization engine to receive a fee for providing the location-based mobile social connection service.

11. The computer-implemented method of claim 1 wherein enabling/disabling social interaction among the participants comprises enabling said participants to view, send, receive, and block messages from another participant within the zone.

12. A location-based mobile social connection tool provided on a client device, said location-based mobile social connection tool comprising:
a graphical user interface facilitating user interaction with a location-based mobile social connection service hosted on a server, said graphical user interface performing:
accepting input comprising socially relevant data from a user of the client device;
accepting a check-in request from the user while said user is present in a zone participating in the location-based mobile social connection service;
providing a check-in screen comprising a social selection tool whereby the user selects a social status indicating said user's current willingness to socialize while in the zone; and
responsive to receiving confirmation from the location-based mobile social connection service that the user has successfully checked in to the zone, performing:
revealing the social status and the socially relevant data of said user to other participants checked into the zone where said user is currently checked in;
providing the social status and the socially relevant data of other participants in the zone where the first user is currently checked in; and
enabling/disabling social interaction among participants in the zone, depending on social status selections.

13. The location-based mobile social connection tool of claim 12 operably coupled with a location tool providing a location of the user's client device to the server.

14. The location-based mobile social connection tool of claim 13 wherein the social selection tool comprises:
a first selectable graphical image representing a high willingness to socialize with the other participants in the zone;
a second selectable graphical image representing a limited willingness to socialize with the other participants in the zone; and
a third selectable graphical image indicating no willingness to socialize with the other participants in the zone;
wherein the first, second, and third selectable graphical images are visually distinguishable from each other such that the social status is easily identified.

15. The location-based mobile social connection tool of claim 14 wherein the first, second, and third selectable graphical images comprise radio buttons in different and distinct colors.

16. A computer-implemented location-based mobile social connection system comprising:
a mobile social connection tool comprising a graphical user interface provided on a client device associated with a first user, said mobile social connection tool facilitating user interaction with a location-based mobile social connection service hosted on a server;
wherein said graphical user interface is configured to receive:
input comprising socially relevant data from the first user; and
a check-in request from the first user while said first user is present in a zone participating in the location-based mobile social connection service; and
the server hosting the location-based mobile social connection service, said server comprising:
a check-in engine configured to confirm check-in upon receiving the check-in request and a social status of the first user indicating said first user's current willingness to socialize while in the zone;
an interaction control engine operably coupled with the check-in engine;
wherein the check-in engine checks in the first user to the zone, said checking in comprising:
revealing the social status and the socially relevant data of the first user to other participants in the zone where said first user is currently checked in; and
providing the social status and the socially relevant data of other participants in the zone where the first user is currently checked in; and
wherein the interaction control engine enables/disables social interaction among participants in the zone, depending on the social status selections; and
a monitoring engine monitoring a continued presence and the social status selections of participants in the zone.

17. The computer-implemented location-based mobile social connection system of claim 16 wherein the server further comprises a monetization engine configured to receive a fee for providing the location-based mobile social connection service.

18. The computer-implemented location-based mobile social connection system of claim 16 further comprising a register engine configured to:
register the first user with the location-based mobile social connection service;
propagate a user profile with the input provided by the first user, said input selected from a group consisting of: a name, a nickname, gender, age, hobbies, interests, beverage of choice, marital status, likes, and dislikes; and
storing the user profile in a data store associated with the server.

19. The computer-implemented location-based mobile social connection system of claim 16 wherein the monitoring engine monitors the continued presence and social status by:
continuously monitoring the location of a checked-in participant by querying a positioning tool of the client device; and
checking out the checked-in participant from a zone when said checked-in participant is determined to have left said zone.

20. The computer-implemented location-based mobile social connection system of claim 16 further comprising a location/zone engine configured to perform:
receiving a request to locate a zone within proximity to the first user's client device;
accessing a location of the first user's client device;
providing a location of an at least one zone that is in close proximity to the location of the first user's client device; and
providing a count of participants currently located within the at least one zone.
